(19) United States
(12) Patent Application Publication
(10) Pub. No.: US 2025/0220012 A1
(43) Pub. Date: Jul. 3, 2025

(54) Security Certificate Management During Network Function (NF) Lifecycle

(71) Applicant: Telefonaktiebolaget LM Ericsson (publ), Stockholm (SE)

(72) Inventors: Bernard Smeets, Dalby (SE); Pablo Martinez de la Cruz, Madrid (ES); Sune Gustafsson, Öxabäck (SE); Songmao Li, Shanghai (CN); Mikael Eriksson, Alingsås (SE); Christine Jost, Dalby (SE); Stere Preda, Longueuil (CA); Ferhat Karakoc, Istanbul (TR)

(21) Appl. No.: 18/853,498

(22) PCT Filed: Apr. 24, 2023
(86) PCT No.: PCT/EP2023/060612

§ 371 Date: Oct. 2, 2024

(30) Foreign Application Priority Data
May 5, 2022 (WO) PCT/CN2022/090870

(51) Int. Cl. H04L 9/40; H04L 41/0686; H04L 41/40

(52) U.S. Cl. CPC H04L 63/0823; H04L 41/0686; H04L 41/40

(57) ABSTRACT

Embodiments include methods for a certificate authority (CA) associated with a communication network, including first and/or second sets of operations. The first set includes receiving a first message about a network function (NF) lifecycle management (LCM) event performed by a first NF of the communication network. The first message includes an identifier of a second NF associated with the NF LCM event, and an event type associated with the NF LCM event. The first operations include performing a first certificate LCM event for certificate(s) associated with the second NF, based on the event type. The second set includes performing a second certificate LCM event for the certificate(s) associated with the second NF and sending the first NF a second message about the second certificate LCM event. The second message includes an identifier of the second NF and an event type associated with the certificate LCM event.

### TECHNICAL FIELD

The present disclosure relates generally to communication networks and more specifically to techniques for synchronizing lifecycle management (LCM) of network functions (NFs) of a communication network and LCM of security certificates used by such NFs, which are typically performed by different entities.

### BACKGROUND

The fifth generation (5G) of cellular systems was initially standardized 3GPP Rel-15 and continues to evolve in subsequent releases. NR is developed for maximum flexibility to support a variety of different use cases including enhanced mobile broadband (eMBB), machine type communications (MTC), ultra-reliable low latency communications (URLLC), side-link device-to-device (D2D), and several other use cases. 5G/NR technology shares many similarities with fourth-generation Long Term Evolution (LTE).

At a high level, the 5G System (5GS) consists of an Access Network (AN) and a Core Network (CN). The AN provides UEs connectivity to the CN, e.g., via base stations such as gNBs or ng-eNBs. As described in more detail below, the CN includes a variety of Network Functions (NF) that provide a range of different functionalities such as session management, connection management, charging, authentication, etc.

FIG. 1 illustrates a high-level view of an exemplary 5G wireless network 100, which includes a Next Generation Radio Access Network (NG-RAN, 199) and a 5G Core (5GC, 198). The NG-RAN can include one or more gNodeB's (gNBs, e.g., 100, 150) connected to the 5GC via one or more NG interfaces (e.g., 102, 152). More specifically, the gNBs can be connected to one or more Access and Mobility Management Functions (AMFs) in the 5GC via respective NG-C interfaces and to one or more User Plane Functions (UPFs) in the 5GC via respective NG-U interfaces. Various other network functions (NFs) can be included in the 5GC, as described in more detail below.

In addition, the gNBs can be connected to each other via one or more Xn interfaces (e.g., 140 between gNBs 100 and 150). The radio technology for the NG-RAN is often referred to as “New Radio” (NR). With respect to the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells.

The NG-RAN is layered into a Radio Network Layer (RNL) and a Transport Network Layer (TNL). The NG-RAN logical nodes and interfaces between them are part of the RNL. For each NG-RAN interface (NG, Xn, F1) the related TNL protocol and the functionality are specified. The TNL provides services for user plane transport and signaling transport.

The NG RAN logical nodes shown in FIG. 1 include a Centralized Unit (CU or gNB-CU) and one or more Distributed Units (DU or gNB-DU). CUs (e.g., 110) are logical nodes that host higher-layer protocols and perform various gNB functions such controlling the operation of DUs. In contrast, DUs (e.g., 120, 130) are decentralized logical nodes that host lower layer protocols and can include, depending on the functional split option, various subsets of the gNB functions. As such, each of the CUs and DUs can include various circuitry needed to perform their respective functions, including processing circuitry, transceiver circuitry (e.g., for communication), and power supply circuitry.

A gNB-CU connects to one or more gNB-DUs over respective F1 logical interfaces (e.g., 122, 132 in FIG. 1). However, a gNB-DU can be connected to only a single gNB-CU. The gNB-CU and connected gNB-DU(s) are only visible to other gNBs and the 5GC as a gNB. In other words, the F1 interface is not visible beyond gNB-CU.

One change in 5G networks (e.g., in 5GC) is that traditional peer-to-peer interfaces and protocols found in earlier-generation networks are modified and/or replaced by a Service Based Architecture (SBA) in which Network Functions (NFs) provide one or more services to one or more service consumers. This can be done, for example, by Hyper Text Transfer Protocol/Representational State Transfer (HTTP/REST) application programming interfaces (APIs). In general, the various services are self-contained functionalities that can be changed and modified in an isolated manner without affecting other services.

Furthermore, the services are composed of various “service operations”, which are more granular divisions of the overall service functionality. The interactions between service consumers and producers can be of the type “request/response” or “subscribe/notify”. In the 5G SBA, network repository functions (NRF) allow every network function to discover the services offered by other network functions, and Data Storage Functions (DSF) allow every network function to store its context. This 5G SBA model is based on principles including modularity, reusability and self-containment of NFs, which can enable network deployments to take advantage of the latest virtualization and software technologies.

5GC includes a Network Repository Function (NRF), whose services are defined in 3GPP TS 29.510 (v17.5.0). These services include a management-related service called “Nnrf_NFManagement” and a discovery-related service called “Nnrf_NFDiscovery”. Nnrf_NFManagement allows NF Instances and Service Communication Proxy (SCP) instances to register, update, or deregister their profiles in the NRF. The NRF uses the registered NF profiles in the Nnrf_NFDiscovery service, specifically to facilitate NF and SCP Instances to discover other NF instances that offer services of interest.

Authentication and communication security between NFs and other entities in SBA are based on transport layer security (TLS) and HTTPS (also referred to as HTTP over TLS), which are defined by the Internet Engineering Task Force (IETF). 3GPP TS 33.501 (v17.5.0) section 13 specifies that TLS client and server certificates are used for authentication of consumer NFs (e.g., client) and producer NFs (e.g., server). Once mutually authenticated based on their respective certificates, two NFs can exchange encryption keys that facilitate secure communication between the two NFs.

### SUMMARY

In general, a Certificate Authority (CA) is responsible for lifecycle management (LCM) of certificates, such as issuing new certificates, revocation of existing certificates, etc. The issuing CA is referred to as a certificate's “root of the trust”. Typically, CAs for certificates used for authentication and communication security between NFs and other entities in SBA, are external to and/or independent from the 5GC. For example, the CA may be an independent organization that issues certificates to various entities, including operators of 5G networks.

In contrast, LCM of NFs is performed within the 5GC and, conventionally, in a manner that is independent from the CA's LCM of the certificates relied on by these NFs. As such, the two different LCMs can be unsynchronized, which can cause various problems, issues, and/or difficulties for the CA and/or the 5G network operator.

Embodiments of the present disclosure provide improved synchronization of LCM for certificates and LCM for NFs that rely on such certificates, such as by facilitating solutions to overcome exemplary problems summarized above and described in more detail below.

Some embodiments include methods (e.g., procedures) for CA associated with a communication network (e.g., 5GC). These exemplary methods can include a first set of operations and/or a second set of operations. The first set of operations includes receiving a first message about a NF LCM event performed by a first NF of the communication network. The first message includes an identifier of a second NF associated with the NF LCM event performed by the first NF and an event type associated with the NF LCM event. The first set of operations also includes performing a first certificate LCM event for one or more certificates associated with the second NF. The first certificate LCM event is based on the event type associated with the NF LCM event.

The second set of operations includes performing a second certificate LCM event for the one or more certificates associated with the second NF and sending to the first NF a second message about the second certificate LCM event. The second message includes an identifier of the second NF and an event type associated with the certificate LCM event.

In some embodiments, the first message is about a NF LCM event performed by a NRF of the communication network. In other embodiments, the first message is about a virtual NF LCM event performed by a NF virtualization management and orchestration function (NFV-MANO) of the communication network.

In some embodiments, the first NF is an NRF and the first message is received from the NRF via an intermediate certificate management network entity (CMNE) associated with the communication network. In other embodiments, the first NF is an NRF and the first message is received from the NRF without an intermediate CMNE. In other embodiments, the first NF is an NFV-MANO of the communication network and the first message is received from the NFV-MANO via the intermediate CMNE.

In some embodiments, the first set of operations also includes sending to the first NF a subscribe request for notifications about NF LCM events associated with one or more NFs, including the second NF. In such embodiments, the first message is a notify response to the subscribe request. In some of these embodiments, the subscribe request is for notifications about all NF LCM events associated with all NFs for which the CA maintains certificates.

In some embodiments, the NF LCM event is deregistration of the NF and the first certificate LCM event is revocation of the one or more certificates associated with the second NF. In some embodiments, the second certificate LCM event is revocation of the one or more certificates associated with the second NF.

In some embodiments, the first NF is an NRF and one of the following applies: the second message is sent to the NRF via an intermediate CMNE, or the second message is sent to the NRF without an intermediate CMNE. In some of these embodiments, the second set of operations also includes receiving from the NRF a second subscribe request for notifications about certificate LCM events associated with one or more NFs, including the second NF. In such case, the second message is sent as a notify response to the second subscribe request. In some variants of these embodiments, the second subscribe request is for notifications about all certificate LCM events associated with all NFs registered with the NRF.

Other embodiments include methods (e.g., procedures) for a first NF of a communication network (e.g., 5GC). These exemplary methods can include a first set of operations and/or a second set of operations. The first set of operations includes performing a first NF LCM event for a second NF of the communication network and sending a first message to a CA associated with the communication network. The first message includes an identifier of the second NF on which the first NF LCM event was performed by the first NF, and an event type associated with the first NF LCM event.

The second set of operations include receiving a second message about a certificate LCM event performed by the CA for one or more certificates associated with the second NF. The second message includes an identifier of the second NF, and an event type associated with the certificate LCM event. The second set of operations also includes performing a second NF LCM event for the second NF identified by the second message. The second NF LCM event is based on the event type associated with the certificate LCM event.

In some embodiments, the first NF is an NRF and the first message is sent to the NRF via an intermediate CMNE associated with the communication network. In other embodiments, the first NF is an NRF and the first message is sent to the NRF without an intermediate CMNE. In other embodiments, the first NF is an NFV-MANO of the communication network and the first message is sent to the NFV-MANO via the intermediate CMNE.

In some embodiments, the first set of operations also includes receiving a first subscribe request for notifications about NF LCM events associated with one or more NFs of the communication network, including the second NF. In such embodiments, the first message is sent as a notify response to the first subscribe request. In some variants of these embodiments, the first subscribe request is for notifications about all NF LCM events associated with all NFs for which the CA maintains certificates.

In some embodiments, the first NF is an NRF and the second set of operations also includes sending a second subscribe request for notifications about certificate LCM events associated with one or more NFs of the communication network, including the second NF. In such embodiments, the second message is received as a notify response to the second subscribe request. In some of these embodiments, the second subscribe request is for notifications about all certificate LCM events associated with all NFs registered with the NRF. In some of these embodiments, the second subscribe request is sent to, and the second message is received from, the CA. In other of these embodiments, the second subscribe request is sent to, and the second message is received from, a CMNE associated with the communication network.

In some embodiments, the first NF LCM event is deregistration of the NF. In some embodiments, the certificate LCM event is revocation of the one or more certificates associated with the second NF and the second NF LCM event is deregistration of the second NF.

Other embodiments include methods (e.g., procedures) for a CMNE of a communication network (e.g., 5GC). These exemplary methods can include a first set of operations and/or a second set of operations. The first set of operations includes receiving, from a first NF of the communication network, a first message about a NF LCM event performed by the first NF. The first message includes an identifier of a second NF associated with the NF LCM event performed by the first NF, and an event type associated with the NF LCM event. The first set of operations also includes sending the first message to a CA that maintains certificates associated with NFs of the communication network.

The second set of operations includes receiving from the CA a second message about a certificate LCM event performed by the CA for the one or more certificates associated with the second NF. The second message includes an identifier of the second NF and an event type associated with the certificate LCM event. The second set of operations also includes sending the second message to the first NF.

In some embodiments, the first NF is an NRF of the communication network and the first message is about a NF LCM event performed by the NRF. In other embodiments, the first NF is an NFV-MANO of the communication network and the first message is about a VNF LCM event performed by the NFV-MANO.

In some embodiments, the first set of operations also includes sending to the first NF a first subscribe request for notifications about NF LCM events associated with one or more NFs, including the second NF. In such embodiments, the first message is received as a notify response to the first subscribe request. In some variants, the first subscribe request is for notifications about all NF LCM events associated with all NFs for which the CA maintains certificates.

In some embodiments, the first NF is an NRF and the second set of operations also includes receiving from the NRF a second subscribe request for notifications about certificate LCM events associated with one or more NFs, including the second NF. In such embodiments, the second message is sent as a notify response to the second subscribe request. In some variants, the second subscribe request is for notifications about all certificate LCM events associated with all NFs registered with the NRF.

In some embodiments, the NF LCM event is deregistration of the NF and/or the certificate LCM event is revocation of the one or more certificates associated with the NF identifier. In some embodiments, the CMNE stores a mapping or relation between certificates maintained by the CA and NFs of the communication network.

Other embodiments include CAs, NFs, and CMNEs (or network nodes hosting and/or implementing these functions) configured to perform operations corresponding to any of the exemplary methods described herein. Other embodiments include non-transitory, computer-readable media storing program instructions that, when executed by processing circuitry, configure such CAs, NFs, and CMNEs (or network nodes hosting and/or implementing these functions) to perform operations corresponding to any of the exemplary methods described herein.

These and other embodiments described herein can improve synchronization of NF LCM and certificate LCM, thereby reducing and/or avoiding scenarios such as NFs relying on revoked certificates and/or CA maintaining certificates for deregistered NFs. At a high level, embodiments improve certificate-based security in communication networks such as 5GC.

These and other objects, features, and advantages of embodiments of the present disclosure will become apparent upon reading the following Detailed Description in view of the Drawings briefly described below.

### BRIEF DESCRIPTION OF THE DRAWINGS

FIG. 1 is a high-level block diagram of an exemplary 5G wireless network.

FIG. 2 shows an exemplary architecture for a 5G wireless network with service-based interfaces.

FIG. 3 shows an exemplary service communication proxy (SCP) deployment in 5GC.

FIGS. 4-5 are signaling diagrams of various lifecycle management (LCM) procedures, according to various embodiments of the present disclosure.

FIG. 6 shows an exemplary method (e.g., procedure) for a CA associated with a communication network (e.g., 5GC), according to various embodiments of the present disclosure.

FIG. 7 shows an exemplary method (e.g., procedure) for an NRF of a communication network (e.g., 5GC), according to various embodiments of the present disclosure.

FIG. 8 shows an exemplary method (e.g., procedure) for a CMNE of a communication network (e.g., 5GC), according to various embodiments of the present disclosure.

FIG. 9 shows a communication system according to various embodiments of the present disclosure.

FIG. 10 shows a network node according to various embodiments of the present disclosure.

FIG. 11 shows host computing system according to various embodiments of the present disclosure.

FIG. 12 is a block diagram of a virtualization environment in which functions implemented by some embodiments of the present disclosure may be virtualized.

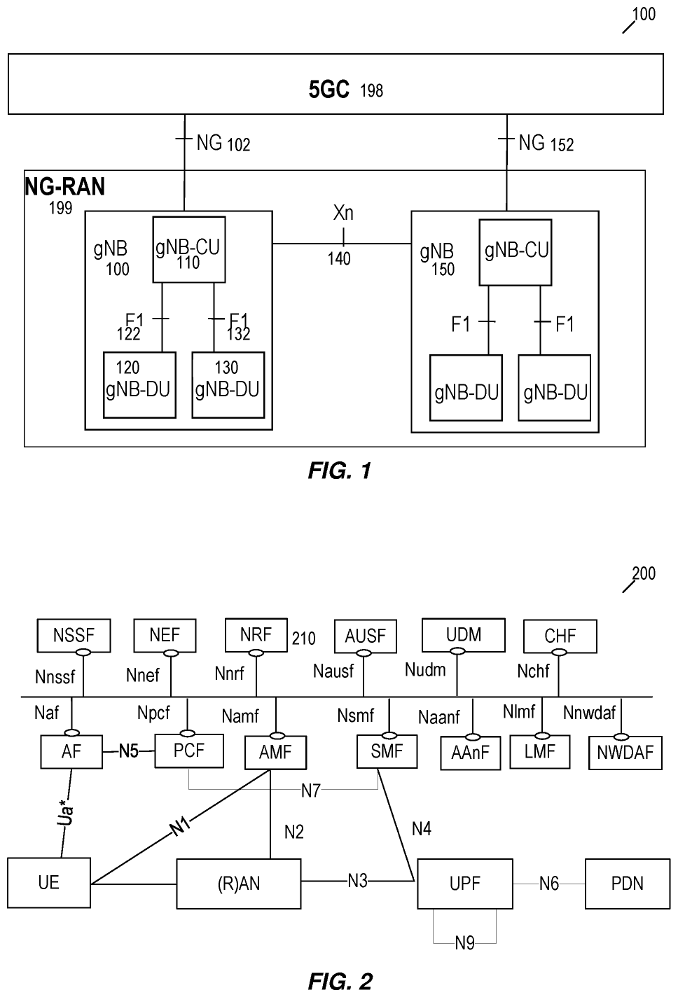

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node) based on its specific characteristics in any given context.

Note that the description herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

FIG. 2 shows an exemplary non-roaming architecture for a 5G wireless network (200) with service-based interfaces. This architecture includes the following NFs:
Application Function (AF, with Naf interface) interacts with the 5GC to provision information to the network operator and to subscribe to certain events happening in operator's network. An AF offers applications for which service is delivered in a different layer (i.e., transport layer) than the one in which the service has been requested (i.e., signaling layer), the control of flow resources according to what has been negotiated with the network. An AF communicates dynamic session information to PCF (via N5 interface), including description of media to be delivered by transport layer.
Policy Control Function (PCF, with Npcf interface) supports unified policy framework to govern the network behavior, via providing PCC rules (e.g., on the treatment of each service data flow that is under PCC control) to the SMF via the N7 reference point. PCF provides policy control decisions and flow based charging control, including service data flow detection, gating, QoS, and flow-based charging (except credit management) towards the SMF. The PCF receives session and media related information from the AF and informs the AF of traffic (or user) plane events.
User Plane Function (UPF)-supports handling of user plane traffic based on the rules received from SMF, including packet inspection and different enforcement actions (e.g., event detection and reporting). UPFs communicate with the RAN (e.g., NG-RNA) via the N3 reference point, with SMFs (discussed below) via the N4 reference point, and with an external packet data network (PDN) via the N6 reference point. The N9 reference point is for communication between two UPFs.
Session Management Function (SMF, with Nsmf interface) interacts with the decoupled traffic (or user) plane, including creating, updating, and removing Protocol Data Unit (PDU) sessions and managing session context with the User Plane Function (UPF), e.g., for event reporting. For example, SMF performs data flow detection (based on filter definitions included in PCC rules), online and offline charging interactions, and policy enforcement.
Charging Function (CHF, with Nchf interface) is responsible for converged online charging and offline charging functionalities. It provides quota management (for online charging), re-authorization triggers, rating conditions, etc. and is notified about usage reports from the SMF. Quota management involves granting a specific number of units (e.g., bytes, seconds) for a service. CHF also interacts with billing systems.
Access and Mobility Management Function (AMF, with Namf interface) terminates the RAN CP interface and handles all mobility and connection management of UEs (similar to MME in EPC). AMFs communicate with UEs via the N1 reference point and with the RAN (e.g., NG-RAN) via the N2 reference point.
Network Exposure Function (NEF) with Nnef interface—acts as the entry point into operator's network, by securely exposing capabilities and events provided by 3GPP NFs to AFs within and outside of the 5GC. NEF also enables AFs to securely provide information to 3GPP NFs. For example, NEF provides a service that allows an AF to provision specific subscription data (e.g., expected UE behavior) for various UEs.
Network Repository Function (NRF, 210) with Nnrf interface—provides service registration and discovery, enabling NFs to discover appropriate services available from other NFs.
Network Slice Selection Function (NSSF) with Nnssf interface—a “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice. The NSSF enables other NFs (e.g., AMF) to identify a network slice instance that is appropriate for a UE's desired service.
Authentication Server Function (AUSF) with Nausf interface—based in a user's home network (HPLMN), it performs user authentication and computes security key materials for various purposes.
Network Data Analytics Function (NWDAF) with Nnwdaf interface—interacts with other NFs to collect relevant data and provides network analytics information (e.g., statistical information of past events and/or predictive information) to other NFs.
Location Management Function (LMF) with Nlmf interface—supports various functions related to determination of UE locations, including location determination for a UE and obtaining any of the following: DL location measurements or a location estimate from the UE; UL location measurements from the NG RAN; and non-UE associated assistance data from the NG RAN.
Unified Data Management (UDM) function with Nudm interface—supports generation of 3GPP authentication credentials, user identification handling, access authorization based on subscription data, and other subscriber-related functions. To provide this functionality, the UDM uses subscription data (including authentication data) stored in the 5GC unified data repository (UDR). The terms “UDM” and “UDM function” are used interchangeably herein.

UDR also supports storage and retrieval of policy data by the PCF, as well as storage and retrieval of application data by NEF. Although not shown, Data Storage Functions (DSF) allow every NF to store its context.

Service Communication Proxy (SCP) is a 5GC NF that was introduced in Rel-16. SCP provides centralized capabilities such as service-based interface (SBI) routing, NF discovery and selection, failover, message screening, etc. More generally, SCP facilitates 5GC implementation in a highly distributed multi-access edge compute cloud environment. SCP provides a single point of entry for a cluster of NFs after they have been successfully discovered by the NRF. As such, the SCP becomes the delegated discovery point in a data center, offloading NRF from the distributed service meshes that can comprise a network operator's infrastructure.

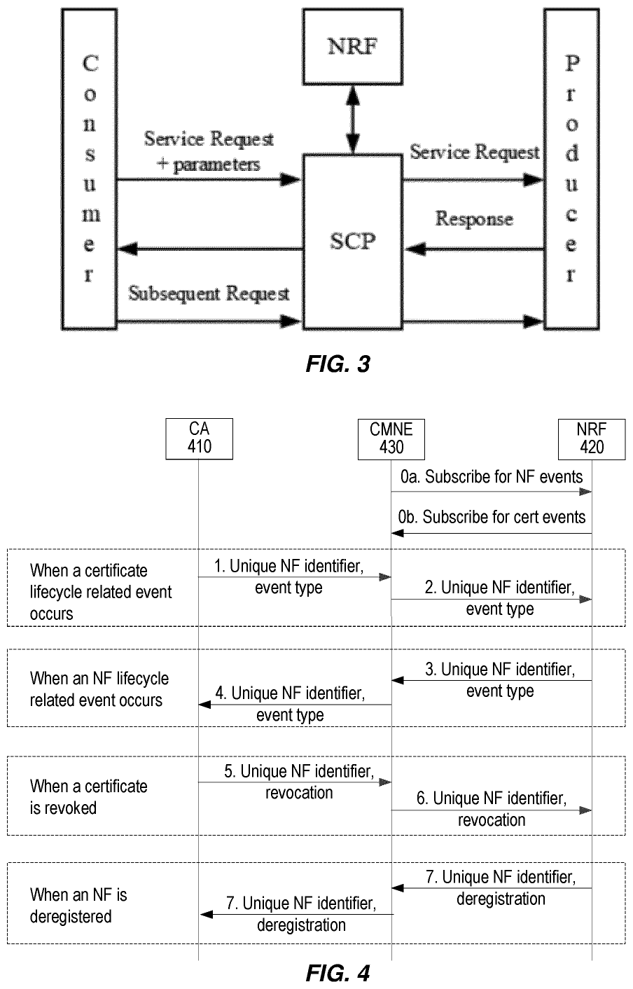

FIG. 3 shows an exemplary deployment of an SCP in a 5GC, which is further described in 3GPP TS 23.501 (v17.3.0) Annex E incorporated herein by reference in its entirety. In this example, the SCP discovers the NF service producer (“producer” or “NFp”) via NRF on behalf of the NF service consumer (“consumer” or “NFc”). As such, the NFc (e.g., the NEF discussed above) does not have to interact directly with NRF in contrast to arrangements without SCPs.

As briefly mentioned above, authentication and communication security between NFS, SCPs, and other 5GC entities are based on TLS and HTTPS defined by IETF. 3GPP TS 33.501(v17.5.0) section 13 specifies that TLS client and server certificates are used for authentication of consumer NFs (e.g., client) and producer NFs (e.g., server). Once mutually authenticated based on their respective certificates, two NFs can exchange encryption keys that facilitate secure communication between the two NFs.

Certificate Authorities (CAs) are responsible for lifecycle management (LCM) of certificates, such as issuing new certificates, revocation of existing certificates, etc. The issuing CA is referred to as a certificate's “root of the trust”. Typically, certificates used for authentication and communication security between NFs and other 5GC entities, are issued by CAs that are external to and/or independent from the 5GC. For example, the CA may be an independent organization that issues certificates to various entities, including but not limited to operators of 5G networks.

In contrast, LCM of NFs is performed within the 5GC and in a manner that is independent from CA LCM of the certificates relied on by these NFs. This can cause various problems, issues, and/or difficulties for the CA and/or the 5G network operator.

For example, when an NF's certificate has expired or been revoked by the CA, the NRF that registered the NF's profile is not aware of the invalid certificate and continues to provide the Nnrf_NFDiscovery service on behalf of the NF. When other NFs discover the NF via the Nnrf_NFDiscovery service, they attempt to connect to the NF but discover in the HTTPS/TLS handshake that the NF's certificate is no longer valid. These NFs then must use the Nnrf_NFDiscovery service to find another NF that provides the service of interest, which causes unwanted delay and excess signaling traffic within the 5GC.

As another example, the NRF may determine (or receive an indication) that services offered by a given NF are not to be used any longer. Although the NRF stops providing the Nnrf_NFDiscovery service on behalf of the NF, the CA is not aware of this and continues to maintain the NF's certificate, e.g., as valid or active.

Accordingly, embodiments of the present disclosure provide novel, flexible, and efficient techniques whereby an NRF and a CA can inform each other about LCM events pertaining to an NF and a certificate used by the NF. For example, these techniques can include a first one of these entities (e.g., NRF) subscribing for notifications from a second one of these entities (e.g., CA) about relevant LCM events. Based on the subscription, the second entity notifies the first entity when a particular LCM event (e.g., associated with a unique identifier) occurs. The subscription and notification may be done directly between the first and second entities, or via a third entity (e.g., newly-defined NF) that acts as an intermediary. In this manner, embodiments can improve the synchronization of NF LCM and certificate LCM, thereby reducing and/or avoiding the exemplary problems mentioned above.

FIG. 4 show a signaling diagram for LCM procedures, according to some embodiments of the present disclosure. In particular, the signaling shown in FIG. 4 is between a CA (410), an NRF (420), and a Certificate Management Network Entity (CMNE, 430). Although the operations in FIG. 4 are given numerical labels, this is done to facilitate explanation and is not intended to imply any specific ordering of the operations, unless expressly stated to the contrary.

CMNE can be a newly-defined network entity or NF that facilitates synchronization of LCM events between NRF and CA. The name “CMNE” is merely an example, and the same functionality may be labelled with various other names. Although CMNE is shown in FIG. 4 as a separate entity (e.g., in 5GC), it can also be part of the CA or the NRF. Alternatively, CMNE functionality can be distributed among NFs that are subject to LCM by NRF and certificate LCM by CA. For example, each NF instance may include CMNE functionality.

In the arrangement shown in FIG. 4, CMNE may communicate with NRF via a service based interface (SBI) that uses HTTP/2 (over TLS) with JSON for application layer serialization. SBI lower layers include TCI, IP, and any appropriate layer 2 (L2). In case CMNE is collocated with an NF, it can communicate with NRF via an existing interface, e.g., as a newly-defined service or service operation.

CMNE is considered a trusted entity since it interacts with NRF and CA. Being a trusted entity, CMNE may also interact with virtualization orchestration entities in NF cloud deployments. For example, CMNE may be an authorized consumer of the network function virtualization management and orchestration (NFV-MANO) interfaces defined in ETSI GS-NFV 006 (“Management and Orchestration; Architectural Framework Specification”). This capability can provide better visibility to certificates for each virtualized NF (VNF), thereby enabling better control (or processing) of certificate LCM events and VNF LCM events. Accordingly, a NFV-MANO may perform similar operations as performed by NRF in FIG. 4, except with respect to VNFs rather than NFs.

In operation 0, CMNE subscribes to NRF for NF LCM events and NRF subscribes to CMNE for certificate LCM events. In some embodiments, each subscription may identify one or more particular LCM events, one or more particular NFs, etc. to which the subscription applies. Alternately, each subscription may be for all NFs and/or for all LCM events.

In operation 1, when an LCM event for an NF certificate occurs at the CA, the CA sends to CMNE a unique identifier of the NF and a type associated with the LCM event (event type).

In operation 2, based on the NRF's subscription covering the identified NF and the event type (or covering all NFs and/or all certificate LCM events), the CMNE forwards the information received in operation 1 to the NRF using a notify procedure (e.g., described in SBA). The NRF then performs any necessary NF LCM operations accordingly.

In operation 3, when an LCM event for an NF occurs at the NRF, the NRF sends to CMNE a unique identifier of the NF and a type associated with the LCM event (event type) using a notify procedure (e.g., described in SBA). This notification is based on the CMNE's subscription covering the identified NF and the event type (or covering all NFs and/or all NF LCM events). In operation 3, the CMNE forwards the information received in operation 3 to the CA. The CA performs then performs any necessary certificate LCM operations accordingly. Note that operations 3-4 may be independent of operations 1-2, and vice versa.

Operations 5-6 can be viewed as a specific example of operations 1-2, respectively. In operation 5, when the CA revokes an NF certificate, the CA sends to CMNE a unique identifier of the NF and a type associated with the LCM event (revocation). In operation 6, based on the NRF's subscription covering the identified NF and certificate revocations (or covering all NFs and/or all certificate LCM events), the CMNE forwards the information received in operation 5 to the NRF using a notify procedure. The NRF then performs any necessary NF LCM operations, such as deregistering the identified NF.

Operations 7-8 can be viewed as a specific example of operations 3-4, respectively. In operation 7, when the NRF deregisters an NF, the NRF sends to CMNE a unique identifier of the NF and a type associated with the LCM event (deregistration) using the notify procedure. This notification is based on the CMNE's subscription covering the identified NF and deregistration events (or covering all NFs and/or all NF LCM events). In operation 8, the CMNE forwards the information received in operation 7 to the CA. The CA performs then performs any necessary certificate LCM operations, such as revoking the certificate for the identified NF. Note that operations 7-8 may be independent of operations 5-6, and vice versa.

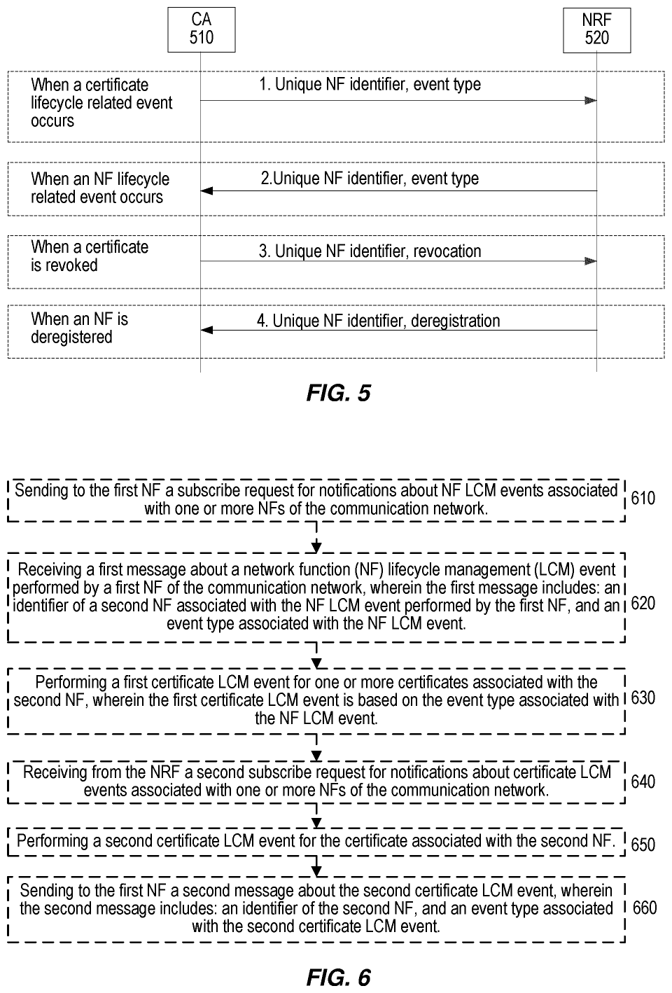

FIG. 5 shows another signaling diagram for LCM procedures, according to other embodiments of the present disclosure. In particular, the signaling shown in FIG. 5 is between a CA (510) and an NRF (520), without involvement of a CMNE. In other words, LCM event notification takes place directly between CA and NRF. Although the operations in FIG. 5 are given numerical labels, this is done to facilitate explanation and is not intended to imply any specific ordering of the operations, unless expressly stated to the contrary.

Although not shown in FIG. 5, CA and NRF can subscribe to each other for LCM events, such as in FIG. 4 operation 0. In that case, all LCM event information will be sent as notifications based on NRF/CA subscription covering the identified NF and the LCM event type (or covering all NFs and/or all certificate LCM events).

In operation 1, when an LCM event for an NF certificate occurs at the CA, the CA sends to the NRF a unique identifier of the NF and a type associated with the LCM event (event type). The NRF then performs any necessary NF LCM operations accordingly.

In operation 2, when an LCM event for an NF occurs at the NRF, the NRF sends to the CA a unique identifier of the NF and a type associated with the LCM event (event type). The CA performs then performs any necessary certificate LCM operations accordingly. Note that operation 2 may be independent of operation 1, and vice versa.

Operation 3 can be viewed as a specific example of operation 1. In operation 3, when the CA revokes an NF certificate, the CA sends to the NRF a unique identifier of the NF and a type associated with the LCM event (revocation). The NRF then performs any necessary NF LCM operations, such as deregistering the identified NF.

Operation 4 can be viewed as a specific example of operation 2. In operation 4, when the NRF deregisters an NF, the NRF sends to the CA a unique identifier of the NF and a type associated with the LCM event (deregistration). The CA performs then performs any necessary certificate LCM operations, such as revoking the certificate for the identified NF. Note that operation 3 may be independent of operation 4, and vice versa.

Upon receiving the information in any of operations 1-4 in FIGS. 4-5, the receiving entity (i.e., NRF or CA) can perform one or more LCM events or operations based on the received information. For example, upon receiving the information about the certificate revocation in operation 3, the NRF can deregister the NF associated with the revoked certificate, as identified in operation 3. As another example, upon receiving the information about NF deregistration in operation 4, the CA can revoke any certificates associated with the deregistered NF, as identified in operation 4.

In some cases, the CA may maintain (e.g., in PKI) both a client certificate and a server certificate for an NF. A client certificate is used for authentication of the NF as a consumer NF, while the server certificate is used for authentication of the NF as a producer NF and for encryption of data. In the embodiments described above, CMNE (FIG. 4) or CA (FIG. 5) can coordinate LCM of client and server certificates for each NF. This can avoid, for example, revoking an NF's server certificate while leaving the NF's client certificate active in PKI. To accomplish this coordination, CMNE (FIG. 4) or CA (FIG. 5) may be configured with information about which certificates belong to which NFs (e.g., a mapping or a grouping).

The embodiments described above are further illustrated by FIGS. 6-8, which depict exemplary methods (e.g., procedures) for a CA, an NRF, and a CMNE, respectively. Put differently, various features of the operations described below correspond to various embodiments described above. The exemplary methods shown in FIGS. 6-8 can be used cooperatively (e.g., with each other and with other procedures described herein) to provide benefits, advantages, and/or solutions to problems described herein. Although the exemplary methods are illustrated in FIGS. 6-8 by specific blocks in particular orders, the operations corresponding to the blocks can be performed in different orders than shown and can be combined and/or divided into blocks and/or operations having different functionality than shown. Optional blocks and/or operations are indicated by dashed lines.

In particular, FIG. 6 illustrates an exemplary method (e.g., procedure) for a CA operable with a communication network (e.g., 5GC), according to various embodiments of the present disclosure. For example, the exemplary method shown in FIG. 6 can be performed by an NEF (or a network node hosting the same) such as described elsewhere herein.

The exemplary method can include a first set of operations and/or a second set of operations. The first set of operations includes blocks 620-630. In block 620, the CA can receive a first message about a NF LCM event performed by a first NF of the communication network. The first message includes an identifier of a second NF associated with the NF LCM event performed by the first NF and an event type associated with the NF LCM event. In block 630, the CA can perform a first certificate LCM event for one or more certificates associated with the second NF (i.e., the NF identified by the identifier received in block 620). The first certificate LCM event is based on the event type associated with the NF LCM event.

The second set of operations includes blocks 650-660, where the CA can perform a second certificate LCM event for the one or more certificates associated with the second NF and send to the first NF a second message about the second certificate LCM event. The second message includes an identifier of the second NF (i.e., on which the certificate LCM event was performed) and an event type associated with the certificate LCM event.

In some embodiments, the first message is about a NF LCM event performed by a network repository function (NRF) of the communication network. In other embodiments, the first message is about a virtual NF (VNF) LCM event performed by a NF virtualization management and orchestration function (NFV-MANO) of the communication network.

In some embodiments, the first NF is an NRF and the first message is received from the NRF via an intermediate certificate management network entity (CMNE) associated with the communication network. FIG. 4 shows an example of these embodiments. In other embodiments, the first NF is an NRF and the first message is received from the NRF without an intermediate CMNE. FIG. 5 shows an example of these embodiments. In other embodiments, the first NF is an NFV-MANO of the communication network and the first message is received from the NFV-MANO via the intermediate CMNE.

In some embodiments, the first set of operations also include block 610, where the CA can send to the first NF a subscribe request for notifications about NF LCM events associated with one or more NFs, including the second NF identified by the first message. In such embodiments, the first message is a notify response to the subscribe request. In some of these embodiments, the subscribe request is for notifications about all NF LCM events associated with all NFs for which the CA maintains certificates.

In some embodiments, the NF LCM event is deregistration of the NF and the first certificate LCM event is revocation of the one or more certificates associated with the second NF. In some embodiments, the second certificate LCM event is revocation of the one or more certificates associated with the second NF.

In some embodiments, the first NF is an NRF and one of the following applies: the second message is sent to the NRF via an intermediate CMNE, or the second message is sent to the NRF without an intermediate CMNE. In some of these embodiments, the second set of operations also includes the operations of block 640, where the CA can receive from the NRF a second subscribe request for notifications about certificate LCM events associated with one or more NFs, including the second NF. In such case, the second message is sent as a notify response to the second subscribe request. In some variants of these embodiments, the second subscribe request is for notifications about all certificate LCM events associated with all NFs registered with the NRF.

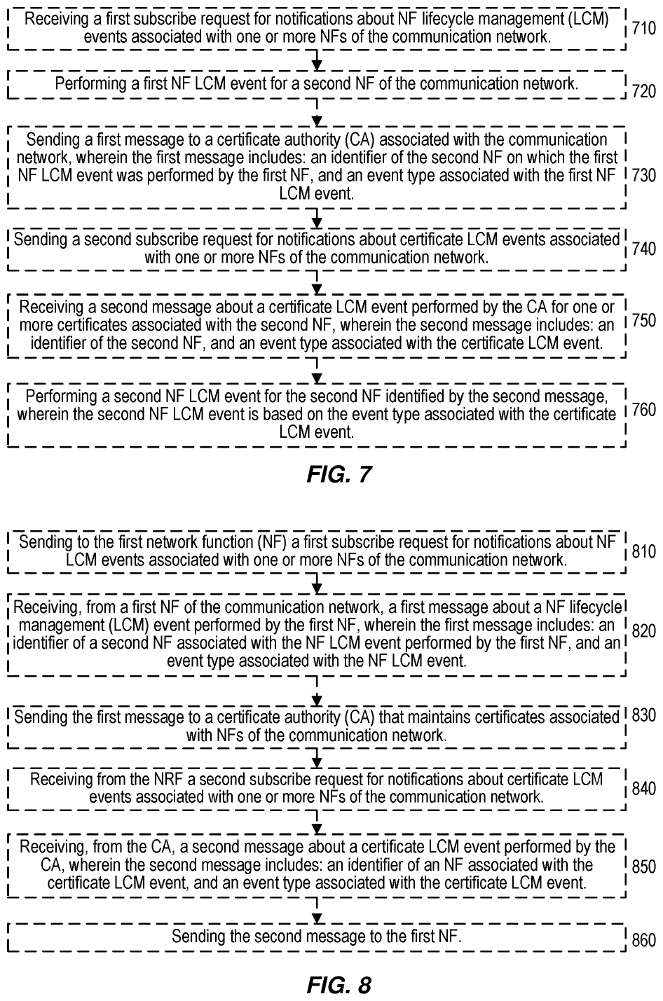

In addition, FIG. 7 illustrates an exemplary method (e.g., procedure) for a first NF of a communication network (e.g., 5GC), according to various embodiments of the present disclosure. For example, the exemplary method shown in FIG. 7 can be performed by an NRF (or a network node hosting the same) such as described elsewhere herein.

The exemplary method can include a first set of operations and/or a second set of operations. The first set of operations includes blocks 720-730, where the first NF can perform a first NF LCM event for a second NF of the communication network and send a first message to a CA associated with the communication network. The first message includes an identifier of the second NF on which the first NF LCM event was performed by the first NF, and an event type associated with the first NF LCM event.

The second set of operations include blocks 750-760. In block 750, the first NF can receive a second message about a certificate LCM event performed by the CA for one or more certificates associated with the second NF. The second message includes an identifier of the second NF (i.e., on which the certificate LCM event was performed), and an event type associated with the certificate LCM event. In block 760, the first NF can perform a second NF LCM event for the second NF identified by the second message. The second NF LCM event is based on the event type associated with the certificate LCM event.

In some embodiments, the first NF is an NRF and the first message is sent to the NRF via an intermediate certificate management network entity (CMNE) associated with the communication network. FIG. 4 shows an example of these embodiments. In other embodiments, the first NF is an NRF and the first message is sent to the NRF without an intermediate CMNE. FIG. 5 shows an example of these embodiments. In other embodiments, the first NF is an NFV-MANO of the communication network and the first message is sent to the NFV-MANO via the intermediate CMNE.

In some embodiments, the first set of operations also includes block 710, where the first NF can receive a first subscribe request for notifications about NF LCM events associated with one or more NFs of the communication network, including the second NF. In such embodiments, the first message is sent as a notify response to the first subscribe request. In some variants of these embodiments, the first subscribe request is for notifications about all NF LCM events associated with all NFs for which the CA maintains certificates.

In some embodiments, the first NF is an NRF and the second set of operations also includes block 740, where the NRF can send a second subscribe request for notifications about certificate LCM events associated with one or more NFs of the communication network, including the second NF. In such embodiments, the second message is received (e.g., in block 760) as a notify response to the second subscribe request. In some of these embodiments, the second subscribe request is for notifications about all certificate LCM events associated with all NFs registered with the NRF. In some of these embodiments, the second subscribe request is sent to, and the second message is received from, the CA. In other of these embodiments, the second subscribe request is sent to, and the second message is received from, a CMNE associated with the communication network.

In some embodiments, the first NF LCM event is deregistration of the NF. In some embodiments, the certificate LCM event is revocation of the one or more certificates associated with the second NF and the second NF LCM event is deregistration of the second NF.

In addition, FIG. 8 illustrates an exemplary method (e.g., procedure) for a CMNE operable with a communication network (e.g., 5GC), according to various embodiments of the present disclosure. For example, the exemplary method shown in FIG. 8 can be performed by a CMNE (or a network node hosting the same or similar functionality) such as described elsewhere herein.

The exemplary method can include a first set of operations and/or a second set of operations. The first set of operations includes blocks 820-830. In block 820, the CMNE can receive, from a first NF of the communication network, a first message about a NF LCM event performed by the first NF. The first message includes an identifier of a second NF associated with the NF LCM event performed by the first NF, and an event type associated with the NF LCM event. In block 830, the CMNE can send the first message to a CA that maintains certificates associated with NFs of the communication network.

The second set of operations includes blocks 850-860. In block 850, the CMNE can receive from the CA a second message about a certificate LCM event performed by the CA for the one or more certificates associated with the second NF. The second message includes an identifier of the second NF and an event type associated with the certificate LCM event. In block 860, the CMNE can send the second message to the first NF.

In some embodiments, the first NF is an NRF of the communication network and the first message is about a NF LCM event performed by the NRF. In other embodiments, the first NF is an NFV-MANO of the communication network and the first message is about a VNF LCM event performed by the NFV-MANO.

In some embodiments, the first set of operations also includes block 810, where the CMNE can send to the first NF a first subscribe request for notifications about NF LCM events associated with one or more NFs, including the second NF. In such embodiments, the first message is received as a notify response to the first subscribe request. In some variants, the first subscribe request is for notifications about all NF LCM events associated with all NFs for which the CA maintains certificates.

In some embodiments, the first NF is an NRF and the second set of operations also includes block 840, where the CMNE can receive from the NRF a second subscribe request for notifications about certificate LCM events associated with one or more NFs, including the second NF. In such embodiments, the second message is sent (e.g., in block 860) as a notify response to the second subscribe request. In some variants, the second subscribe request is for notifications about all certificate LCM events associated with all NFs registered with the NRF.

In some embodiments, the NF LCM event is deregistration of the NF and/or the certificate LCM event is revocation of the one or more certificates associated with the NF identifier. In some embodiments, the CMNE stores a mapping or relation between certificates maintained by the CA and NFs of the communication network.

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

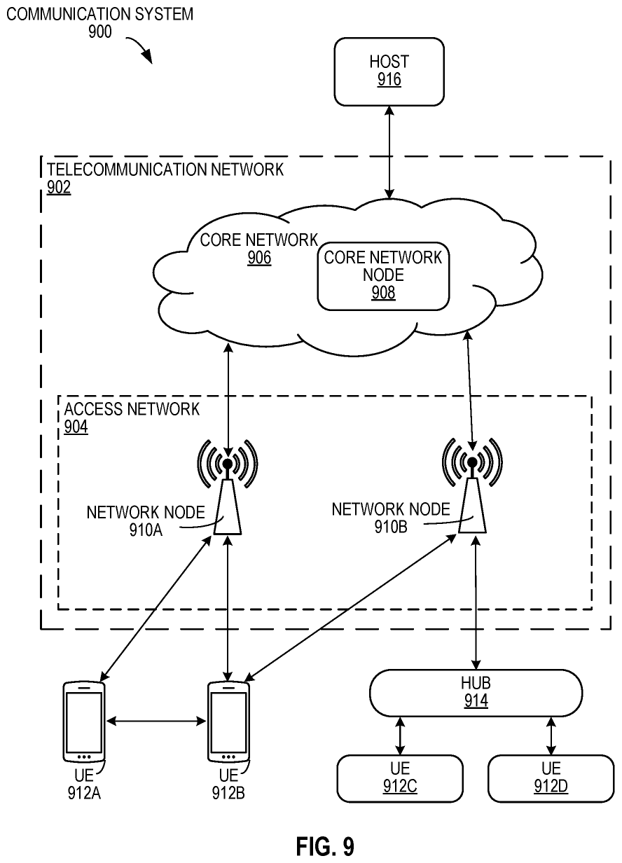

FIG. 9 shows an example of a communication system 900 in accordance with some embodiments. In this example, communication system 900 includes a telecommunication network 902 that includes an access network 904 (e.g., RAN) and a core network 906, which includes one or more core network nodes 908. Access network 904 includes one or more access network nodes, such as network nodes 910a-b (one or more of which may be generally referred to as network nodes 910), or any other similar 3GPP access node or non-3GPP access point. Network nodes 910 facilitate direct or indirect connection of UEs, such as by connecting UEs 912a-d (one or more of which may be generally referred to as UEs 912) to core network 906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 900 may include any number of wired or wireless networks, network nodes, UEs, and/or any other components or systems that may facilitate or participate in the communication of data and/or signals whether via wired or wireless connections. Communication system 900 may include and/or interface with any type of communication, telecommunication, data, cellular, radio network, and/or other similar type of system.

UEs 912 may be any of a wide variety of communication devices, including wireless devices arranged, configured, and/or operable to communicate wirelessly with network nodes 910 and other communication devices. Similarly, network nodes 910 are arranged, capable, configured, and/or operable to communicate directly or indirectly with UEs 912 and/or with other network nodes or equipment in telecommunication network 902 to enable and/or provide network access, such as wireless network access, and/or to perform other functions, such as administration in telecommunication network 902.

In the depicted example, core network 906 connects network nodes 910 to one or more hosts, such as host 916. These connections may be direct or indirect via one or more intermediary networks or devices. In other examples, network nodes may be directly coupled to hosts. Core network 906 includes one or more core network nodes (e.g., core network node 908) that are structured with hardware and software components. Features of these components may be substantially similar to those described with respect to the UEs, network nodes, and/or hosts, such that the descriptions thereof are generally applicable to the corresponding components of core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM) function, Unified Data Repository (UDR), Service Communication Proxy (SCP), Network Repository Function (NRF), Security Edge Protection Proxy (SEPP), Network Exposure Function (NEF), Certificate Network Management Entity (CMNE), and/or a User Plane Function (UPF).

Host 916 may be under the ownership or control of a service provider other than an operator or provider of access network 904 and/or telecommunication network 902, and may be operated by the service provider or on behalf of the service provider. Host 916 may host a variety of applications to provide one or more services. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server. As another specific example, host 916 can be configured to provide certificate authority (CA) functionality and/or CMNE functionality, such as described elsewhere herein.

As a whole, communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 902 is a cellular network that implements 3GPP standardized features. Accordingly, telecommunication network 902 may support network slicing to provide different logical networks to different devices that are connected to telecommunication network 902. For example, telecommunication network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 912 are configured to transmit and/or receive information without direct human interaction. For instance, a UE may be designed to transmit information to access network 904 on a predetermined schedule, when triggered by an internal or external event, or in response to requests from access network 904. Additionally, a UE may be configured for operating in single-or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, hub 914 communicates with access network 904 to facilitate indirect communication between one or more UEs (e.g., UE 912c and/or 912d) and network nodes (e.g., network node 910b). In some examples, hub 914 may be a controller, router, content source and analytics, or any of the other communication devices described herein regarding UEs. For example, hub 914 may be a broadband router enabling access to core network 906 for the UEs. As another example, hub 914 may be a controller that sends commands or instructions to one or more actuators in the UEs. Commands or instructions may be received from the UEs, network nodes 910, or by executable code, script, process, or other instructions in hub 914. As another example, hub 914 may be a data collector that acts as temporary storage for UE data and, in some embodiments, may perform analysis or other processing of the data. As another example, hub 914 may be a content source. For example, for a UE that is a VR headset, display, loudspeaker or other media delivery device, hub 914 may retrieve VR assets, video, audio, or other media or data related to sensory information via a network node, which hub 914 then provides to the UE either directly, after performing local processing, and/or after adding additional local content. In still another example, hub 914 acts as a proxy server or orchestrator for the UEs, in particular if one or more of the UEs are low energy IoT devices.

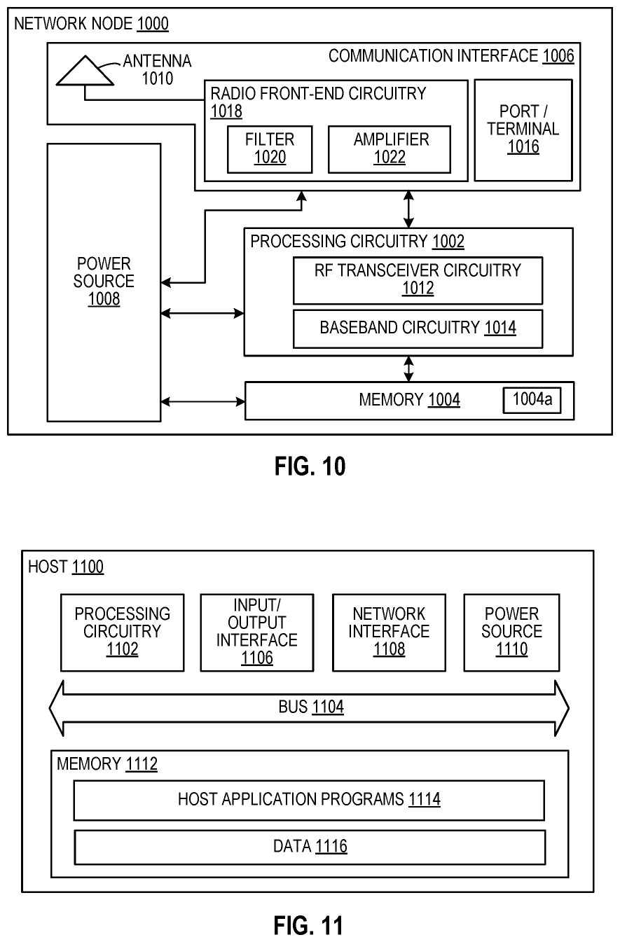

FIG. 10 shows a network node 1000 in accordance with some embodiments. Examples of network nodes include, but are not limited to, access points (e.g., radio access points) and base stations (e.g., radio base stations, Node Bs, eNBs, and gNBs). Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., E-SMLCs), and/or Minimization of Drive Tests (MDTs). Other examples of network nodes include any network node that hosts a network function (NF), such as any of the NFs that were described above.

Network node 1000 includes processing circuitry 1002, a memory 1004, a communication interface 1006, and a power source 1008. Network node 1000 may be composed of multiple physically separate components (e.g., a NodeB component and a RNC component, or a BTS component and a BSC component, etc.), which may each have their own respective components. In certain scenarios in which network node 1000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1000 may be configured to support multiple radio access technologies (RATs). In such embodiments, some components may be duplicated (e.g., separate memory 1004 for different RATs) and some components may be reused (e.g., a same antenna 1010 may be shared by different RATs). Network node 1000 may also include multiple sets of the various illustrated components for different wireless technologies integrated into network node 1000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1000.

Processing circuitry 1002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1000 components, such as memory 1004, to provide network node 1000 functionality.

In some embodiments, processing circuitry 1002 includes a system on a chip (SOC). In some embodiments, processing circuitry 1002 includes one or more of radio frequency (RF) transceiver circuitry 1012 and baseband processing circuitry 1014. In some embodiments, the radio frequency (RF) transceiver circuitry 1012 and baseband processing circuitry 1014 may be on separate chips (or sets of chips), boards, or units, such as radio units and digital units. In alternative embodiments, part or all of RF transceiver circuitry 1012 and baseband processing circuitry 1014 may be on the same chip or set of chips, boards, or units.

Memory 1004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1002. Memory 1004 may store any suitable instructions, data, or information, including a computer program, software, an application including one or more of logic, rules, code, tables, and/or other instructions (collectively denoted computer program 1004a, which may be a computer program product) capable of being executed by processing circuitry 1002 and utilized by network node 1000. Memory 1004 may be used to store any calculations made by processing circuitry 1002 and/or any data received via communication interface 1006. In some embodiments, processing circuitry 1002 and memory 1004 is integrated.

Communication interface 1006 is used in wired or wireless communication of signaling and/or data between a network node, access network, and/or UE. As illustrated, communication interface 1006 comprises port(s)/terminal(s) 1016 to send and receive data, for example to and from a network over a wired connection. Communication interface 1006 also includes radio front-end circuitry 1018 that may be coupled to, or in certain embodiments a part of, antenna 1010. Radio front-end circuitry 1018 comprises filters 1020 and amplifiers 1022. Radio front-end circuitry 1018 may be connected to an antenna 1010 and processing circuitry 1002. The radio front-end circuitry may be configured to condition signals communicated between antenna 1010 and processing circuitry 1002. Radio front-end circuitry 1018 may receive digital data that is to be sent out to other network nodes or UEs via a wireless connection. Radio front-end circuitry 1018 may convert the digital data into a radio signal having the appropriate channel and bandwidth parameters using a combination of filters 1020 and/or amplifiers 1022. The radio signal may then be transmitted via antenna 1010. Similarly, when receiving data, antenna 1010 may collect radio signals which are then converted into digital data by radio front-end circuitry 1018. The digital data may be passed to processing circuitry 1002. In other embodiments, the communication interface may comprise different components and/or different combinations of components.

In certain alternative embodiments, network node 1000 does not include separate radio front-end circuitry 1018, instead, processing circuitry 1002 includes radio front-end circuitry and is connected to antenna 1010. Similarly, in some embodiments, all or some of RF transceiver circuitry 1012 is part of communication interface 1006. In still other embodiments, communication interface 1006 includes one or more ports or terminals 1016, radio front-end circuitry 1018, and RF transceiver circuitry 1012, as part of a radio unit (not shown), and communication interface 1006 communicates with baseband processing circuitry 1014, which is part of a digital unit (not shown).

Antenna 1010 may include one or more antennas, or antenna arrays, configured to send and/or receive wireless signals. Antenna 1010 may be coupled to radio front-end circuitry 1018 and may be any type of antenna capable of transmitting and receiving data and/or signals wirelessly. In certain embodiments, antenna 1010 is separate from network node 1000 and connectable to network node 1000 through an interface or port.

Antenna 1010, communication interface 1006, and/or processing circuitry 1002 may be configured to perform any receiving operations and/or certain obtaining operations described herein as being performed by the network node. Any information, data and/or signals may be received from a UE, another network node and/or any other network equipment. Similarly, antenna 1010, communication interface 1006, and/or processing circuitry 1002 may be configured to perform any transmitting operations described herein as being performed by the network node. Any information, data and/or signals may be transmitted to a UE, another network node and/or any other network equipment.

Power source 1008 provides power to the various components of network node 1000 in a form suitable for the respective components (e.g., at a voltage and current level needed for each respective component). Power source 1008 may further comprise, or be coupled to, power management circuitry to supply the components of network node 1000 with power for performing the functionality described herein. For example, network node 1000 may be connectable to an external power source (e.g., the power grid, an electricity outlet) via an input circuitry or interface such as an electrical cable, whereby the external power source supplies power to power circuitry of power source 1008. As a further example, power source 1008 may comprise a source of power in the form of a battery or battery pack which is connected to, or integrated in, power circuitry. The battery may provide backup power should the external power source fail.

Embodiments of network node 1000 may include additional components beyond those shown in FIG. 10 for providing certain aspects of the network node's functionality, including any of the functionality described herein and/or any functionality necessary to support the subject matter described herein. For example, network node 1000 may include user interface equipment to allow input of information into network node 1000 and to allow output of information from network node 1000. This may allow a user to perform diagnostic, maintenance, repair, and other administrative functions for network node 1000.

In some embodiments, different variants of network node 1000 can implement and/or host various network functions described herein, such as NRF and CMNE. In such embodiments, the components of network node 1000 can be configured to perform operations corresponding to methods (e.g., procedures) described herein as being performed by such entities.

FIG. 11 is a block diagram of a host 1100, which may be an embodiment of host 916 of FIG. 9, in accordance with various aspects described herein. As used herein, host 1100 may be or comprise various combinations hardware and/or software, including a standalone server, a blade server, a cloud-implemented server, a distributed server, a virtual machine, container, or processing resources in a server farm. Host 1100 may provide one or more services to one or more UEs.

Host 1100 includes processing circuitry 1102 that is operatively coupled via a bus 1104 to an input/output interface 1106, a network interface 1108, a power source 1110, and a memory 1112. Other components may be included in other embodiments. Features of these components may be substantially similar to those described with respect to previous figures, such as FIG. 10.

Memory 1112 may include one or more computer programs including one or more host application programs 1114 and data 1116, which may include user data, e.g., data generated by a UE for host 1100 or data generated by host 1100 for a UE. Embodiments of host 1100 may utilize only a subset or all of the components shown. Host application programs 1114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1114 may also provide for user authentication and licensing checks and may periodically report health, routes, and content availability to a central node, such as a device in or on the edge of a core network. Accordingly, host 1100 may select and/or indicate a different host for over-the-top services for a UE. Host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

As another example, host 1100 may provide the functionality of a CA and/or a CMNE, as described above. In such embodiments, the components of host 1100 (including application programs 1114 and data 1116) can be configured to perform operations corresponding to methods (e.g., procedures) described herein as being performed by a CA and/or by a CMNE. Host 1100 may include or be coupled to secure storage for storing certificates. For example, memory 1112 can include such secure storage. In some variants, separate instances of host 1100 can be configured to perform operations corresponding to respective methods (e.g., procedures) described herein as being performed by a CA and by a CMNE.

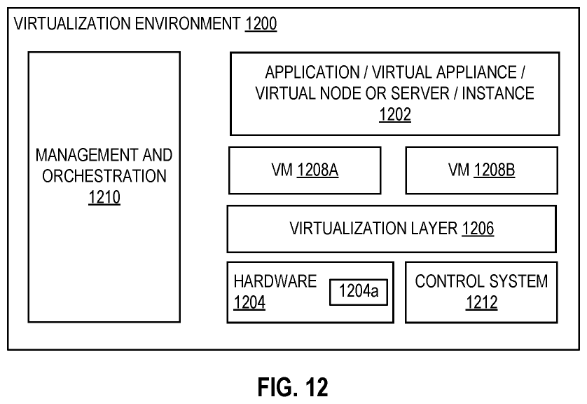

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1202 (which may alternatively be called software instances, virtual appliances, network functions, virtual nodes, virtual network functions, etc.) are run in the virtualization environment 1200 to implement some of the features, functions, and/or benefits of some of the embodiments disclosed herein. For example, one or more of a CA, an NRF, and a CMNE described herein can be implemented as virtual nodes or virtual NFs in virtualization environment 1200.

Hardware 1204 includes processing circuitry, memory that stores software and/or instructions (collectively denoted computer program 1204a, which may be a computer program product) executable by hardware processing circuitry, and/or other hardware devices as described herein, such as a network interface, input/output interface, and so forth. Software may be executed by the processing circuitry to instantiate one or more virtualization layers 1206 (also referred to as hypervisors or virtual machine monitors (VMMs)), provide VMs 1208a-b (one or more of which may be generally referred to as VMs 1208), and/or perform any of the functions, features and/or benefits described in relation with some embodiments described herein. The virtualization layer 1206 may present a virtual operating platform that appears like networking hardware to the VMs 1208.

VMs 1208 comprise virtual processing, virtual memory, virtual networking or interface and virtual storage, and may be run by a corresponding virtualization layer 1206. Different embodiments of the instance of a virtual appliance 1202 may be implemented on one or more VMs 1208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 1208 may be a software implementation of a physical machine that runs programs as if they were executing on a physical, non-virtualized machine. Each VM 1208, and that part of hardware 1204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1208 on top of hardware 1204 and corresponds to application 1202.

Hardware 1204 may be implemented in a standalone network node with generic or specific components. Hardware 1204 may implement some functions via virtualization. Alternatively, hardware 1204 may be part of a larger cluster of hardware (e.g., such as in a data center or CPE) where many hardware nodes work together and are managed via management and orchestration 1210, which, among others, oversees lifecycle management of applications 1202. In some embodiments, hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1212 which may alternatively be used for communication between hardware nodes and radio units.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

1.-39. (canceled)

40. A method performed by a certificate authority (CA) operable with a communication network, the method comprising a first set of operations and/or a second set of operations, wherein:
the first set of operations includes:
receiving a first message about a network function (NF) lifecycle management (LCM) event performed by a first NF of the communication network, wherein the first message includes:
an identifier of a second NF associated with the NF LCM event performed by the first NF, and
an event type associated with the NF LCM event; and
performing a first certificate LCM event for one or more certificates associated with the second NF, wherein the first certificate LCM event is based on the event type associated with the NF LCM event; and
the second set of operations includes:
performing a second certificate LCM event for the one or more certificates associated with the second NF;
sending to the first NF a second message about the second certificate LCM event,
wherein the second message includes:
an identifier of the second NF, and
an event type associated with the second certificate LCM event.

41. The method of claim 40, wherein the first message is about one of the following:
a NF LCM event performed by a network repository function (NRF) of the communication network; or
a virtual NF (VNF) LCM event performed by a NF virtualization management and orchestration function (NFV-MANO) of the communication network.

42. The method of claim 40, wherein one of the following applies:
the first NF is a network repository function (NRF) and the first message is received from the NRF via an intermediate certificate management network entity (CMNE) associated with the communication network;
the first NF is a NF virtualization management and orchestration function (NFV-MANO) of the communication network and the first message is received from the NFV-MANO via the intermediate CMNE; or
the first NF is an NRF and the first message is received from the NRF without an intermediate CMNE.

43. The method of claim 40, wherein:
the first set of operations also include sending to the first NF a subscribe request for notifications about NF LCM events associated with one or more NFs of the communication network, including the second NF; and
the first message is a notify response to the subscribe request.

44. The method of claim 43, wherein the subscribe request is for notifications about all NF LCM events associated with all NFs for which the CA maintains certificates.

45. The method of claim 40, wherein the NF LCM event is deregistration of the NF, and the first certificate LCM event is revocation of the one or more certificates associated with the second NF.

46. The method of claim 40, wherein the second certificate LCM event is revocation of the one or more certificates associated with the second NF.

47. The method of claim 49, wherein the first NF is a network repository function (NRF) and one of the following applies:
the second message is sent to the NRF via an intermediate certificate management network entity (CMNE); or
the second message is sent to the NRF without an intermediate CMNE.

48. The method of claim 47, wherein:
the second set of operations also includes receiving from the NRF a second subscribe request for notifications about certificate LCM events associated with one or more NFs, including the second NF; and
the second message is sent as a notify response to the second subscribe request.

49. A method performed by a first network function (NF) of a communication network, the method comprising a first set of operations and/or a second set of operations, wherein:
the first set of operations includes:
performing a first NF lifecycle management (LCM) event for a second NF of the communication network; and
sending a first message to a certificate authority (CA) associated with the communication network, wherein the first message includes:
an identifier of the second NF on which the first NF LCM event was performed by the first NF, and
an event type associated with the first NF LCM event; and
the second set of operations includes:
receiving a second message about a certificate LCM event performed by the CA for one or more certificates associated with the second NF, wherein the second message includes:
an identifier of the second NF, and
an event type associated with the certificate LCM event; and
performing a second NF LCM event for the second NF identified by the second message, wherein the second NF LCM event is based on the event type associated with the certificate LCM event.

50. The method of claim 49, wherein one of the following applies:
the first NF is a network repository function (NRF) and the first message is sent to the NRF via an intermediate certificate management network entity (CMNE) associated with the communication network;
the first NF is a NF virtualization management and orchestration function (NFV-MANO) of the communication network and the first message is sent to the NFV-MANO via the intermediate CMNE; or
the first NF is an NRF and the first message is sent to the NRF without an intermediate CMNE.

51. The method of claim 49, wherein:
the first set of operations also includes receiving a first subscribe request for notifications about NF LCM events associated with one or more NFs of the communication network, including the second NF; and
the first message is sent as a notify response to the first subscribe request.

52. The method of claim 51, wherein the first subscribe request is for notifications about all NF LCM events associated with all NFs for which the CA maintains certificates.

53. The method of claim 49, wherein:
the first NF is a network repository function (NRF);
the second set of operations also includes sending a second subscribe request for notifications about certificate LCM events associated with one or more NFs of the communication network, including the second NF; and
the second message is received as a notify response to the second subscribe request.

54. The method of claim 53, wherein the second subscribe request is sent to, and the second message is received from, one of the following: the CA, or a certificate management network entity (CMNE) associated with the communication network the communication network.

55. The method of claim 53, wherein the second subscribe request is for notifications about all certificate LCM events associated with all NFs registered with the NRF.

56. The method of claim 49, wherein the first NF LCM event is deregistration of the NF.

57. The method of claim 49, wherein the certificate LCM event is revocation of the one or more certificates associated with the second NF, and the second NF LCM event is deregistration of the second NF.

58. Network equipment configured to implement a certificate authority (CA) operable with a communication network, wherein:
the network equipment comprises communication interface circuitry and processing circuitry that are configured to perform a first set of operations and/or a second set of operations,
wherein the first set of operations includes:
receiving a first message about a network function (NF) lifecycle management (LCM) event performed by a first NF of the communication network, wherein the first message includes:
an identifier of a second NF associated with the NF LCM event performed by the first NF, and
an event type associated with the NF LCM event; and
performing a first certificate LCM event for one or more certificates associated with the second NF, wherein the first certificate LCM event is based on the event type associated with the NF LCM event; and
and the second set of operations includes:
performing a second certificate LCM event for the one or more certificates associated with the second NF;
sending to the first NF a second message about the second certificate LCM event, wherein the second message includes:
an identifier of the second NF, and
an event type associated with the second certificate LCM event.

59. Network equipment configured to implement a first network function (NF) operable in a communication network, wherein:
the network equipment comprises communication interface circuitry and processing circuitry that are configured to perform a first set of operations and/or a second set of operations,
wherein the first set of operations includes:
performing a first NF lifecycle management (LCM) event for a second NF of the communication network; and
sending a first message to a certificate authority (CA) associated with the communication network, wherein the first message includes:
an identifier of the second NF on which the first NF LCM event was performed by the first NF, and
an event type associated with the first NF LCM event;
and the second set of operations includes:
receiving a second message about a certificate LCM event performed by the CA for one or more certificates associated with the second NF, wherein the second message includes:
an identifier of the second NF, and
an event type associated with the certificate LCM event; and
performing a second NF LCM event for the second NF identified by the second message, wherein the second NF LCM event is based on the event type associated with the certificate LCM event.
